(19) United States
(12) Patent Application Publication
(10) Pub. No.: US 2007/0210653 A1
(43) Pub. Date: Sep. 13, 2007

(54) MOVING MAGNET ACTUATOR WITH COUNTER-COGGING END-RING AND ASYMMETRICAL ARMATURE STROKE

(76) Inventor: Matthew J. Scanlon, Mount Prospect, IL (US)

Correspondence Address: ZIOLKOWSKI PATENT SOLUTIONS GROUP, SC (ZPS), 136 S WISCONSIN ST, PORT WASHINGTON, WI, 53074, US

(21) Appl. No.: 11/608,200

(22) Filed: Dec. 7, 2006

Related U.S. Application Data
(60) Provisional application No. 60/743,463, filed on Mar. 13, 2006.

(51) Int. Cl. H02K 35/00; H02K 33/00; H01F 7/08

(52) U.S. Cl. 310/15; 335/229; 310/17

(57) ABSTRACT

A moving magnet actuator (MMA) includes a magnetically conductive end-ring that is spaced from a magnet pole piece. The end-ring is constructed and spaced to provide a desired counter or anti-cogging force when the MMA is in a powered state. The MMA is also constructed such that a central portion of its armature stroke is axially displaced from a radial centerline of the magnetically conductive conduit enclosing the MMA components.

### CROSS REFERENCE TO RELATED APPLICATION

The present application is a continuation of and claims priority of U.S. Provisional Patent Application Ser. No. 60/743,463 filed Mar. 13, 2006, the disclosure of which is incorporated herein by reference.

### BACKGROUND OF THE INVENTION

The present invention relates generally to actuators and, more particularly, to a moving magnet actuator (MMA) having an end-ring that provides a counter or anti-cogging force and an asymmetrical armature stroke.

Moving magnet actuators generally comprise an armature containing a sintered, anisotropic, axially-oriented, permanent ring magnet sandwiched between two magnetically conductive pole end pieces that are affixed to a non-conductive shaft. When an electromotive force is imparted on the permanent magnet such as by two in-series, oppositely wound, coils located in a radial air gap between the outer diameter of the magnetically conductive pole pieces and the inner diameter of a magnetically conductive conduit that encloses the MMA components, the shaft will be caused to move axially in a positive or negative direction. The shaft typically extends outside the magnetic conduit and is used to unseat or seat a value or operate as a switch. Such MMAs are commonly used in a number of industrial applications. For example, MMAs are often used to control the fuel feed rate for a diesel engine. Other applications include, but are not limited to liquid heat generators.

The above-described conventional construction of an MMA results in a magnetic circuit that produces an attractive force from one coil or winding and a repelling force by the other coil or winding. The coils operate in the same direction thereby accelerating the armature in either the positive or negative directions, depending upon the polarity of the windings. Magnetic flux lines circulating from the magnetically conductive conduit across one winding through the magnetically conductive pole piece (endplate) through the magnet to the other magnetically conductive pole piece (endplate) and across the other winding back to the magnetically conductive conduit produce the electromotive force that causes translation of the armature relative to the magnetic conduit. Typically, the MMA armature has a range of travel or stroke that is symmetrical about a radially-orientated centerline that is perpendicular to the central axis of the actuator. Moreover, MMA's typically operate according to a force versus position curve that has an umbrella-like shape, such as that illustrated in FIG. 1.

As illustrated in FIG. 1, the greatest magnitude of electromotive force 10 is found in the central portion of the actuator's range of motion, which is defined along the x-axis in inches. Force is defined in pounds along the y-axis. This actuator's range of motion is generally referred to as the actuator's stoke and, as shown in FIG. 1, for most MMA's, more electromotive force is present at the center of the actuator's stoke than at the beginning 12 or the end 14.

This conventional MMA construction produces a “cogging” effect as a result of the armature wanting to center itself relative to the boundaries of the magnetically conductive conduit within which it travels. This cogging effect or force is increasingly additive to the electromagnetic force acting on the armature when the MMA is powered. This additive force reaches a maximum at the radial center of the magnetically conductive conduit. Additionally, when the armature is moving away from the radial center, the cogging force is subtractive to the electromagnetic force acting on the armature. Thus, as the armature moves away from the radial center of the conduit, the cogging force pulls the armature back to the radial center. This subtractive effect is particularly undesirable.

The subtractive force placed on the armature affects the response time of the armature. That is, when the MMA is powered, the armature will translate axially within the conductive conduit it sits. Typically, for the armature to translate from its rest to its fully translated position, the force exerted on the armature by a biasing spring must be overcome. If the spring bias is not overcome, the armature will not reach its fully translated position. Moreover, the armature will reciprocate within the conduit as it “hunts” for a position of equilibrium. In other words, the armature will push against the spring and the spring will push back. The aforementioned cogging effect increases the force necessary to compress the spring. As a result, the armature must compress the spring and overcome the cogging forces placed thereon to reach a fully translated position. It therefore follows that if the cogging force can be reduced or at least countered, the armature must only overcome the k-factor of the spring when going from an initial to a fully translated (open) position. Accordingly, the work needed to translate the armature is increased by the cogging force.

Therefore, if the work needed to translate the armature remains constant, a spring with a reduced k-factor must be used to account for the cogging force. In other words, the force of the spring on the armature and the cogging force are additive. However, if the cogging force is reduced, a spring with an increased k-factor could be used or the amount of work needed to move the armature could be reduced. In the example of using a spring with greater k-factor on the armature, the spring improves the response time of the MMA when the MMA goes from a powered to an un-powered state. In other words, a spring with greater spring-back characteristics quickly returns the armature to its rest position when the electromotive force is removed.

Another drawback of conventional MMA design is the impact a lower pull force has acting on the armature when it is displaced from the center of the magnetically conductive conduit. This is particularly problematic for MMAs not intended to operate bi-directionally.

It would therefore be desirable to design an MMA less susceptible to cogging forces and/or lower pull forces.

### BRIEF DESCRIPTION OF THE INVENTION

The present invention is directed to an MMA that overcomes the aforementioned drawbacks. The MMA is constructed to include a magnetically conductive end-ring that is spaced from a magnet pole piece. The end-ring is constructed and spaced to provide a desired counter or anti-cogging force when the MMA is in a powered state. Thus, the subtractive impact of cogging forces that negatively affect conventional MMAs is mitigated by the attractive force between the end-ring and the MMA armature. The MMA is also preferably constructed to have an asymmetrical armature stroke.

Therefore, in accordance with one aspect of the invention, an actuator is disclosed as having a magnetic conduit and an armature that moves linearly within the magnetic conduit when an electromotive force is placed thereon. The actuator further has a magnetically conductive endplate connected to an end of the magnetic conduit and spaced from the armature. The magnetically conductive endplate places a mitigating force on the armature at least equal to a cogging force acting on the permanent magnet when the armature is in close proximity to a radially-oriented centerline of the magnetic conduit that is perpendicular to a central axis of the armature.

In accordance with another aspect, the invention includes an actuator having a ring-shaped, movable magnet and a non-conductive shaft extending through an inner diameter of the movable magnet. The actuator is constructed to also have a ring-shaped endplate spaced from but magnetically coupled to the movable magnet. The endplate has an inner diameter that together with a gap defined between the endplate and the movable magnet place an attractive force on the movable magnet at least equal to a cogging force placed on the movable magnet.

According to another aspect, the invention is directed to an actuator having a magnetic circuit defined by a conduit, an end-ring, a first pole endplate spaced axially from the end-ring, a magnet, a second pole endplate, and the conduit. The magnetic circuit imparts a cogging force on the magnet when the magnet is disposed in close proximity to a center region of the conduit and imparts a counter-cogging force on the magnet by the end-ring when the magnet moves away from the center region of the conduit.

In accordance with yet another aspect, the invention includes an actuator comprising a magnetically conductive conduit having a radial centerline. The actuator is also constructed to include an armature movable along an axis perpendicular to the radial centerline. The armature has a linear range of motion within the conduit that defines an armature stroke. In this regard, the center of the armature stroke is offset from the radial centerline of the magnetically conductive conduit.

According to yet a further aspect, the invention in embodied in an actuator having means for providing a cogging force when an armature is at or near a center region of a magnetically conductive conduit in which it travels. The actuator further includes means for negating the cogging force when the armature is linearly displaced from the center region.

Various other features, objects and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is a graph illustrating a force vs. position curve for a known MMA.

FIG. 2 is a cross-sectional view of an MMA with a counter-cogging end-ring in accordance with one aspect of the invention.

FIG. 3 is a graph illustrating two force vs. position curves for exemplary MMAs, constructed in accordance with the present invention, relative to the force vs. position curve of FIG. 1.

FIG. 4 is a cross-sectional view of a bi-directional MMA with a pair of counter-cogging end-rings in accordance with another aspect of the invention.

FIG. 5 is a graph illustrating force vs. position curves for the bi-directional MMA shown in FIG. 4.

FIG. 6 is a cross-sectional view of another MMA with a counter-cogging end-ring and asymmetrical offset region of armature stroke in accordance with yet another aspect of the invention.

FIG. 7 is a graph illustrating force vs. position curves for (a) conventional MMA, (b) the MMA shown in FIG. 2, and (c) the MMA shown in FIG. 6.

### DETAILED DESCRIPTION OF THE PREFERRED EMBODIMENT

An exemplary MMA according to one embodiment of the invention is shown in cross-section in FIG. 2. As will be explained in greater detail below, the MMA is constructed to exert a counter or anti-cogging force. The MMA 16 is similar to conventional MMA design in that an armature 17 is designed to have a permanent magnetic ring 18 sandwiched between two magnetically conductive pole end pieces 20, 22 that are affixed to a shaft 24 fabricated of non-conductive material. The ring magnet is preferably a sintered, anisotropic, axially-oriented permanent magnet. Shaft 24 travels in both the positive and negative directions 26, 28, respectively, by an electromotive force produced by two in-series, oppositely wound, coils (windings) 30, 32. The coils 30, 32 are located in the radial air gap 34 between the outer diameter of the magnetically conductive pole pieces 20, 22 and the inner diameter of the magnetically conductive conduit 36. The coils 30, 32 are supported by bobbin 38. Similar to conventional MMA design, MMA 16 has a non-magnetic front bearing 40 and a non-magnetic mounting bracket 42. Opposite the front bearing 40 is a non-magnetic locknut 44 that secures the shaft 24 to the magnetic pole piece 20. The MMA further includes spring 46 that rests against pole piece 20. Preferably, spring 46 must be compressed to translate the shaft axially in direction 26.

The MMA 16 also has an annular endplate 48, that in the embodiment of FIG. 2, is positioned at the spring end of the armature 17. It is contemplated that the end-ring 48 could be integrally formed with the magnetic conduit 36 or be a separate component. The end-ring 48 is spaced from pole piece 20 by an air gap 50. The air gap 50, together with the size of the inner diameter 52 of the end-ring, effectively define an attraction force on the armature 17 that results in the net force acting on the armature as it moves away from the center 54 of the magnetically conductive conduit 36 to be greater than or equal to the force acting on the armature when the armature is in close proximity to the center of the magnetically conductive conduit 36. Thus, the end-ring's inner diameter and spaced relationship relative to pole piece 20 provides an anti-cogging or counter-cogging force. The end-ring is preferably made of steel.

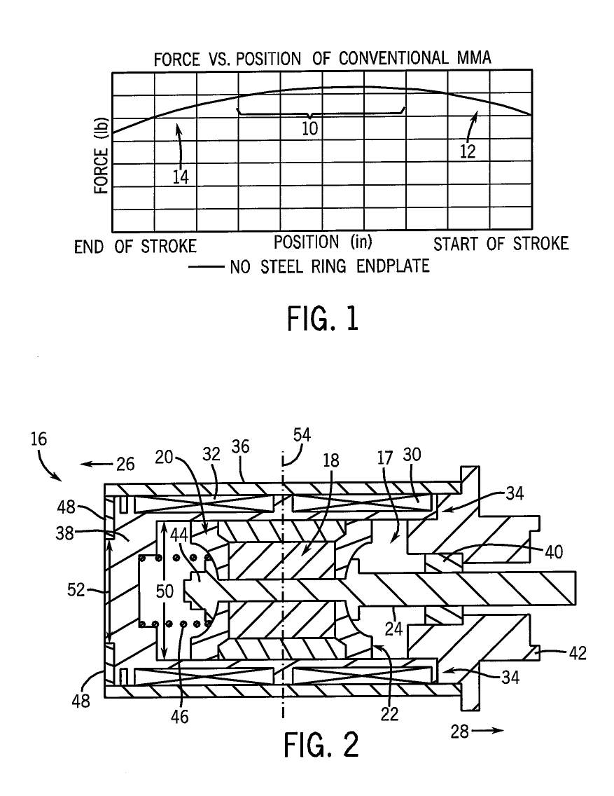

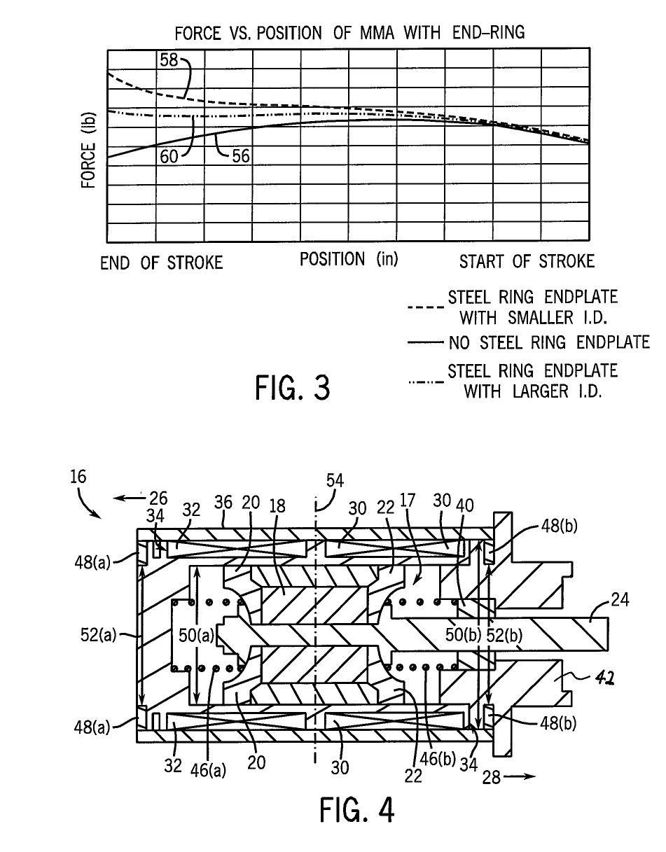

FIG. 3 shows three exemplary force vs. position curves. Curve 56 corresponds to a conventional MMA and is similar to that shown in FIG. 1. Curve 58 corresponds to one embodiment of the invention and curve 60 corresponds to another embodiment. More particularly, curve 58 corresponds to an MMA having an end-ring with a smaller inner diameter that of the MMA corresponding to curve 60. As illustrated, at the beginning of the armature stroke, the force vs. position curves are similar. However, differences are pronounced at the end of the stroke, i.e., position of the armature toward the end-ring. As expected, the curves illustrate that there is an inverse relationship between force and diameter size.

The MMA described with respect to FIG. 2 has a single end-ring. Such a construction is preferred for an MMA when the defined motion of the armature is not to be considered bi-directionally symmetrical. Thus, in the design shown in FIG. 2, the MMA has a single conductive end-ring at the end thereof that the armature is moving in the direction towards and not at the end from which the armature is traveling.

As shown in FIG. 4, an MMA constructed for bi-directionally symmetrical motion is contemplated. The MMA of FIG. 4 is similar to that of FIG. 2, but is constructed to have two end-rings 48(a), 48(b). Moreover, the MMA is constructed to have two biasing springs 46(a), 46(b). Similar to the MMA described at FIG. 2, selection of the end-ring inner diameters 52(a), 52(b) and air gap 50(a), 50(b) widths define the strength of the respective attractive forces placed on the armature 17. In this regard, the MMA is constructed such that force degradation at the end positions of armature travel are reduced as compared to the higher magnitude of force on the armature when it is traveling in the center 54 of the magnetically conductive conduit 36.

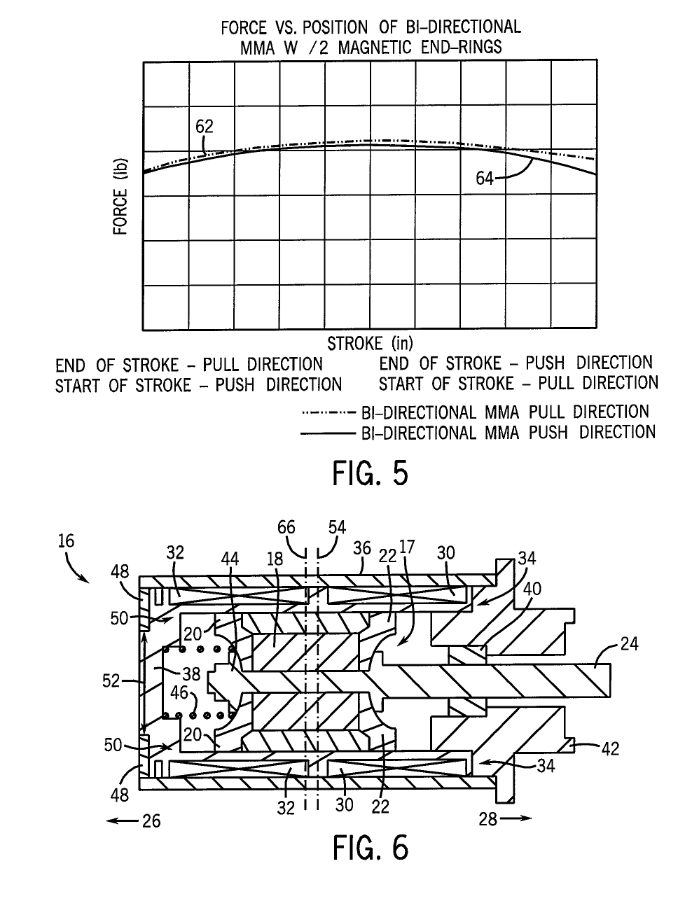

A force vs. position curve for the MMA of FIG. 4 is shown in FIG. 5. As illustrated, the curve in the pull direction 62 is similar to the curve in the push direction 64. Moreover, in both directions, variations in force across the entirety of the armature stroke are small.

As described above, the incorporation of one or more end-rings to provide a counter-cogging force improves the control and response of the MMA. It is also contemplated that additional anti-cogging effects can be provided by reducing the gap between the magnet pole pieces and the magnetically conductive conduit. In this regard, it has been found that reducing the radial gap between the outer diameter of the magnet pole pieces and the inner diameter of the magnetically conductive conduit has been effective in mitigating the cogging force placed on the armature during the central portion of its stroke. Thus, in one preferred embodiment, the magnet pole pieces are increased in size to reduce the aforementioned radial gap.

Referring now to FIG. 6, an MMA constructed in accordance with yet another embodiment of the invention is shown. The construction of the MMA shown in FIG. 6 is to negate the lower pull force that acts upon the armature when the armature is displaced from the radial centerline 54. The MMA illustrated in FIG. 6 is similar to the MMA shown in FIG. 2. That is, the MMA has a single end-ring 48 spaced from magnet pole piece 20 that, as described above, provides a counter or anti-cogging force. However, unlike the MMA illustrated in FIG. 2, the MMA of FIG. 6 is constructed to reduce the lower pull force acting on the armature 17 when the armature is displaced from the center of the magnetically conductive conduit 36.

The lower pull force is mitigated by shifting the central portion of the armature stroke to exist in a region offset from the center of the conduit 36. Thus, the central portion of the armature stroke is aligned with offset centerline 66. In one preferred embodiment, the offset centerline 66 is axially displaced from the conduit centerline 54 by 0.100″. It is contemplated, however, that other displacement magnitudes may be used, but preferably in the range of 0.050-0.150″.

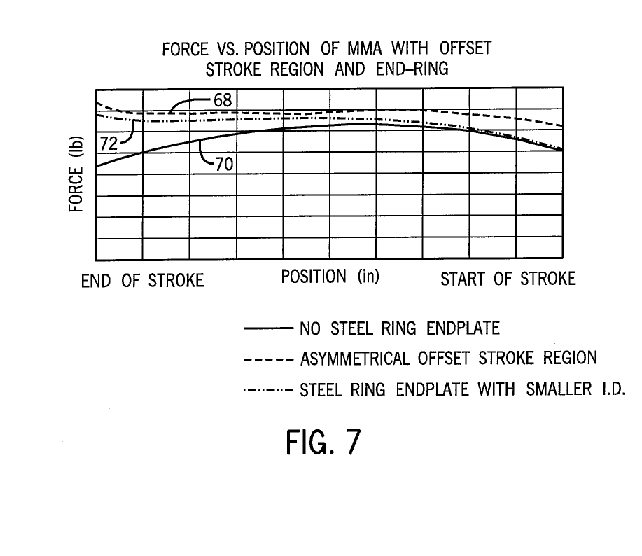

By altering the stroke region of the armature 17 so that it is asymmetrical about the conduit centerline 54, the MMA operates according to a relatively flat-shaped, constant force, force vs. position curve, such as that illustrated in FIG. 7. Operation along a flat-shaped force vs. position curve is much more desirable than the “umbrella”-shaped curve shown in FIG. 1. As shown in FIG. 7, the MMA of FIG. 6 operates according to a significantly flatter force vs. position curve 68 than a conventional MMA (curve 70) or the symmetrically-oriented MMA shown in FIG. 2 (curve 72).

The present invention has been described with respect to an MMA with improved control and response time. One skilled in the art will appreciate that such an MMA will be applicable in a number of industrial applications. In this regard, it is appreciated that the size of the end-ring(s), the air gap(s) between the end-ring(s) and the pole piece(s), etc. can be readily optimized for a given application without departing from the spirit and scope of the appending claims. Additional factors that should be considered in optimizing such an MMA for a given application, are the desired size and weight of the MMA, the travel distance needed for the armature, available power levels, desired accuracy and precision, and the like.

Therefore, in accordance with one embodiment of the invention, an actuator is disclosed as having a magnetic conduit and an armature that moves linearly within the magnetic conduit when an electromotive force is placed thereon. The actuator further has a magnetically conductive endplate connected to an end of the magnetic conduit and spaced from the armature. The magnetically conductive endplate places an mitigating force on the armature at least equal to a cogging force acting on the armature when the armature is in close proximity to a radially-oriented centerline of the magnetic conduit that is perpendicular to a central axis of the armature.

In accordance with another embodiment, the invention includes an actuator having a ring-shaped, movable magnet and a non-conductive shaft extending through an inner diameter of the movable magnet. The actuator is constructed to also have a ring-shaped endplate spaced from but magnetically coupled to the movable magnet. The endplate has an inner diameter that together with a gap defined between the endplate and the movable magnet place an attractive force on the movable magnet at least equal to a cogging force placed on the movable magnet.

According to another embodiment, the invention is directed to an actuator having a magnetic circuit defined by a conduit, an end-ring, a first pole endplate spaced axially from the end-ring, a magnet, a second pole endplate, and the conduit. The magnetic circuit imparts a cogging force on the permanent magnet when the magnet is disposed in close proximity to a center region of the conduit and imparts a counter-cogging force on the magnet by the end-ring when the magnet moves away from the center region of the conduit.

In accordance with yet another embodiment, the invention includes an actuator comprising a magnetically conductive conduit having a radial centerline. The actuator is also constructed to include an armature movable along an axis perpendicular to the radial centerline. The armature has a linear range of motion within the conduit that defines an armature stroke. In this regard, the center of the armature stroke is offset from the radial centerline of the magnetically conductive conduit.

The present invention has been described in terms of the preferred embodiment, and it is recognized that equivalents, alternatives, and modifications, aside from those expressly stated, are possible and within the scope of the appending claims.

1. An actuator comprising:
a magnetic conduit;
an armature that moves linearly within the magnetic conduit when an electromotive force is placed thereon; and
a magnetically conductive endplate connected to an end of the magnetic conduit and spaced from the armature,
wherein the magnetically conductive endplate places an mitigating force on the armature at least equal to a cogging force acting on the armature when the armature is in close proximity to a radially-oriented centerline of the magnetic conduit that is perpendicular to a central axis of the armature.

2. The actuator of claim 1 wherein the armature includes a permanent magnet and the mitigating force is an attractive force that is placed on the permanent magnet.

3. The actuator of claim 2 further comprising a bobbin secured within the magnetic conduit and wherein the armature includes:
a pair of magnet pole end plates secured to opposite ends of the permanent magnet and
a pair of oppositely wound coils wrapped around the bobbin and located in a radial air gap defined between an outer diameter of the pole end plates and an inner diameter of the magnetic conduit.

4. The actuator of claim 3 wherein the armature includes a non-magnetic shaft extending through an inner diameter of the permanent magnet.

5. The actuator of claim 4 wherein the armature further includes a non-magnetic locknut securing the non-magnetic shaft to one magnet pole endplate and a return spring disposed between the bobbin and the one magnet pole endplate.

6. The actuator of claim 1 wherein the magnetically conductive endplate is donut-shaped, and wherein at least one of an inner diameter of the magnetically conductive endplate and an air gap between the magnetically conductive endplate and the magnet is selected to achieve a desired mitigating force.

7. The actuator of claim 1 wherein the armature has a sintered, anisotropic, axially oriented permanent ring magnet.

8. The actuator of claim 1 incorporated into a direct drive, two-terminal, non-commutated, single-phase, limited-motion electric motor.

9. The actuator of claim 1 wherein the armature is situated in the magnetic conduit to be asymmetrical about the radially-oriented centerline that is perpendicular to the central axis of the armature.

10. An actuator comprising:
a ring-shaped, movable magnet;
a non-conductive shaft extending through an inner diameter of the movable magnet; and
a ring-shaped endplate spaced from but magnetically coupled to the movable magnet, the endplate having an inner diameter that together with a gap defined between the endplate and the movable magnet place an attractive force on the movable magnet at least equal to a cogging force placed on the movable magnet.

11. The actuator of claim 10 further comprising a pair of windings that when current is induced therein an electromotive force is placed on the movable magnet to move the movable magnet.

12. The actuator of claim 11 further comprising a magnetic conduit defining a volume having the movable magnet, non-conductive shaft, the pair of windings, and ring-shaped endplate disposed therein, and wherein the pair of windings is spaced apart from one another symmetrically about a radial centerline of the magnetic conduit defined perpendicular to an axis of magnet movement.

13. The actuator of claim 12 wherein the electromotive force imparted decreases in magnitude as axial distance from the radial centerline of the magnetic conduit increases.

14. The actuator of claim 13 wherein the non-conductive shaft is axially displaced from the radial centerline of the magnetic conduit when at rest.

15. The actuator of claim 12 further comprising a spring operably connected to the non-conductive shaft at one end and operably connected to a bobbin supporting the pair of windings at an opposite end.

16. The actuator of claim 10 wherein the non-conductive shaft is caused to move from a rest position towards the ring-shaped end plate when an electromotive force is placed on the movable magnet.

17. The actuator of claim 10 wherein the endplate is formed of steel.

18. An actuator comprising a magnetic circuit defined by a conduit, a end-ring, a first pole endplate spaced axially from the end-ring, a permanent magnet, a second pole endplate, and the conduit, the magnetic circuit imparting a cogging force on the permanent magnet when the permanent magnet is disposed in close proximity to a center region of the conduit and imparting a counter-cogging force on the permanent magnet when the permanent magnet moves away from the center region of the conduit.

19. The actuator of claim 18 wherein a magnitude of the counter-cogging force is at least equal to that of the cogging force.

20. The actuator of claim 19 wherein the magnitude of the counter-cogging force is defined by a combination of at least one of end-ring inner diameter, end-ring thickness, end-ring material composition, and a gap formed between the end-ring and the first pole endplate.

21. An actuator comprising:
a magnetically conductive conduit having a radial centerline;
an armature movable along an axis perpendicular to the radial centerline, the armature having a linear range of motion defining an armature stroke; and
wherein a center of the armature stroke is offset from the radial centerline of the magnetically conductive conduit.

22. The actuator of claim 21 wherein the center of the armature stroke is offset from the radial centerline by a magnitude in the range of 0.050-0.150″.

23. The actuator of claim 22 wherein the magnitude is 0.100″.

24. The actuator of claim 21 wherein the center of the armature stroke is offset in a direction of movement of the armature when the armature is initially exposed to an electromotive force.

25. The actuator of claim 21 wherein the armature includes:
a permanent magnet;
a pair of magnet pole pieces disposed at opposite ends of the permanent magnet; and
an end-ring connected to one end of the magnetically conductive conduit and spaced from a magnet pole piece proximate that end of the magnetically conductive conduit.

26. An actuator comprising:
means for providing a cogging force when an armature is at or near a center region of a magnetically conductive conduit in which it travels; and
means for negating the cogging force when the armature is linearly displaced from the center region.
